(19) United States
(12) Patent Application Publication
(10) Pub. No.: US 2018/0285901 A1
(43) Pub. Date: Oct. 4, 2018

(54) EXPERIENCE OPTIMIZATION FOR A WEBSITE USING AUDIENCE SEGMENTATION DATA

(71) Applicant: CDK Global, LLC, Hoffman Estates, IL (US)

(72) Inventor: Keith Zackrone, Issaquah, WA (US)

(21) Appl. No.: 15/478,048

(22) Filed: Apr. 3, 2017

(51) Int. Cl. G06Q 30/02

(52) U.S. Cl. CPC G06Q 30/0202; G06Q 30/0271; G06Q 30/0242

(57) ABSTRACT

System and methods for optimizing an experience that a user can have at a website using audience segmentation data. Optimizing an experience can include creating the audience segment, from the consumer data, corresponding to the vehicle model from a plurality of vehicle models; generating a plurality of audience weights based on the sales goals data, the vehicle sales data, and the audience segment; generating an augmented consumer profile based on the plurality of audience weights and a consumer profile derived from the audience segment; applying the augmented consumer profile to personalize content on a dealership webpage; and providing the personalized content to a consumer computing device accessing the dealership webpage to optimize a consumer experience.

### TECHNICAL FIELD

The present disclosure relates to experience optimization for a website. In particular, the present disclosure relates to experience optimization for a website using audience segmentation data.

### BACKGROUND

Experience optimization may be limited to evaluating campaign performance against online metrics such as email forms submissions, product page views, etc. Experience optimization can include customizing a customer experience. A customer experience can include content provided to a customer via a website and via emails, among other types of campaign mediums.

### BRIEF DESCRIPTION OF THE DRAWINGS

FIG. 1A is a block diagram of a device according to one embodiment.

FIG. 1B is a block diagram of a device according to one embodiment.

FIG. 2 is a block diagram of a system for experience optimization for a website according to one embodiment.

FIG. 3 is a block diagram for an audience factor module according to one embodiment.

FIG. 4 is a flowchart of a method for experience optimization for a website according to one embodiment.

FIG. 5 is a flowchart of a method for experience optimization for a website according to one embodiment.

FIG. 6 is a flowchart of a method for experience optimization for a website according to one embodiment.

### DETAILED DESCRIPTION OF PREFERRED EMBODIMENTS

The expressed preferences of consumers, as represented in audience segment(s), can be combined with business goals and forecasts to configure the experience (e.g., content/message) consumers receive towards the desired business outcomes by adjusting the consumer audience segments to account for business goals in a consumer consistent way. The consumer can receive content over multiple media channels. Media channels can include a webpage, emails, and/or social media, among other types of media channels.

By aligning the experiences (e.g., experience optimization) and/or messages shown to consumers with the desired business goals, consumer interest can be directed towards preferred business goals, thus maximizing the efficiency of the online audience with respect to offline sales.

Reference is now made to the figures, in which like reference numerals refer to like elements. For clarity, the first digit of a reference numeral indicates the figure number in which the corresponding element is first used. In the following description, numerous specific details are provided for a thorough understanding of the embodiments disclosed herein. However, those skilled in the art will recognize that the embodiments described herein can be practiced without one or more of the specific details, or with other methods, components, or materials. Further, in some cases, well-known structures, materials, or operations are not shown or described in detail in order to avoid obscuring aspects of the embodiments. Furthermore, the described features, structures, or characteristics may be combined in any suitable manner in one or more embodiments.

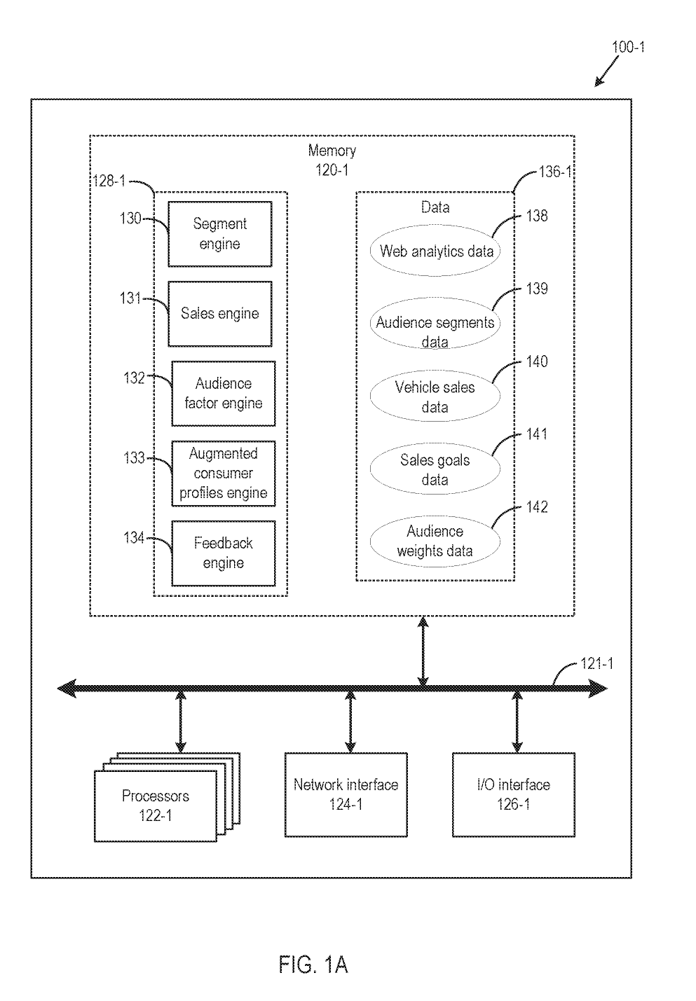

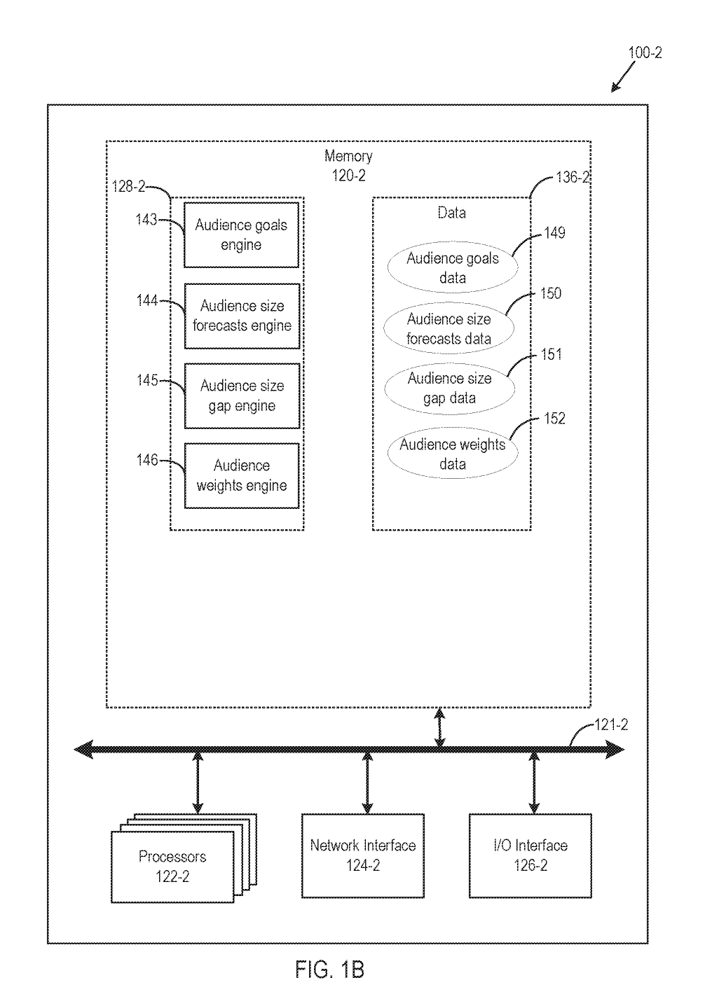

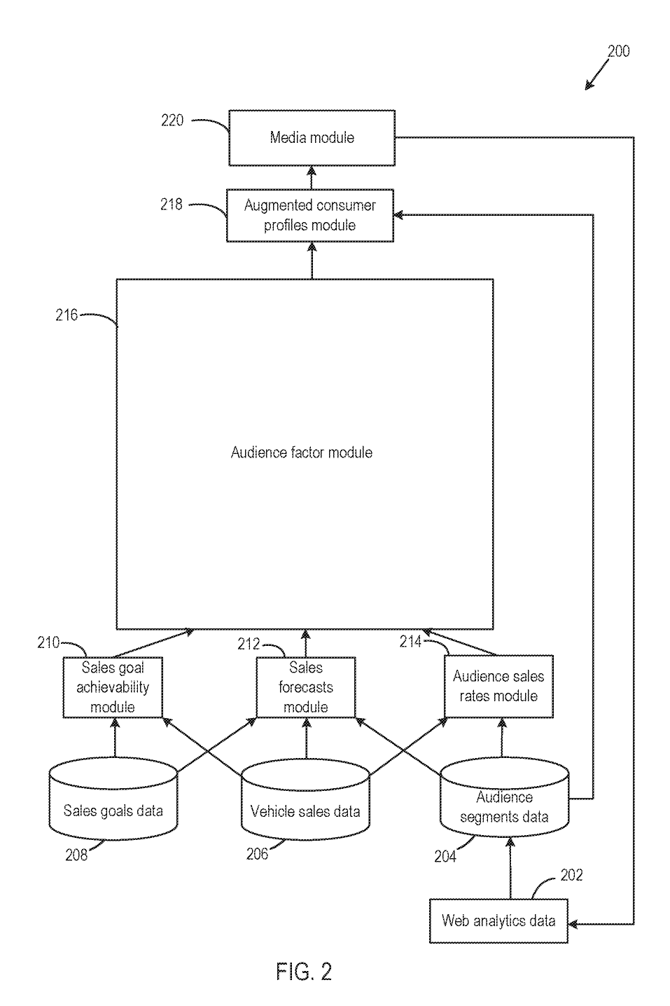

FIG. 1A is a block diagram of a device 100-1 according to one embodiment. The device 100-1 can provide data to the system 200 (FIG. 2) to configure the system 200. The device 100-1 can include a memory 120-1, one or more processors 122-1, a network interface 124-1, an input/output interface 126-1, and a system bus 121-1.

The one or more processors 122-1 may include one or more general-purpose devices, such as an Intel®, AMD®, or other standard microprocessor. The one or more processors 122-1 may include a special-purpose processing device, such as an ASIC, SoC, SiP, FPGA, PAL, PLA, FPLA, PLD, or other customized or programmable device. The one or more processors 122-1 can perform distributed (e.g., parallel) processing to execute or otherwise implement functionalities of the presently disclosed embodiments. The one or more processors 122-1 may run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2®, and so forth.

The memory 120-1 may include static RAM, dynamic RAM, flash memory, one or more flip-flops, ROM, CD-ROM, DVD, disk, tape, or magnetic, optical, or other computer storage medium. The memory 120-1 may include a plurality of program engines 128-1 and program data 136-1. The memory 120-1 may be local to the device 100-1, as shown, or may be distributed and/or remote relative to the experience optimization device 100-1.

The program engines 128-1 may include all or portions of other elements of the system 200. The program engines 128-1 may run multiple operations concurrently or in parallel by or on the one or more processors 122-1. In some embodiments, portions of the disclosed engines, components, and/or facilities are embodied as executable instructions embodied in hardware or in firmware, or stored on a non-transitory, machine-readable storage medium, such as the memory 120-1. The instructions may comprise computer program code that, when executed by a processor and/or computing device, causes a computing system (such as the processors 122-1 and/or the experience optimization device 100-1) to implement certain processing steps, procedures, and/or operations, as disclosed herein. The engines, modules, components, and/or facilities disclosed herein may be implemented and/or embodied as a driver, a library, an interface, an API, FPGA configuration data, firmware (e.g., stored on an EEPROM), and/or the like. In some embodiments, portions of the engines, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like. Accordingly, the engines disclosed herein may be referred to as controllers, layers, services, modules, facilities, drivers, circuits, and/or the like.

The memory 120-1 may also include the program data 136-1. Data generated by the system 200, such as by the program engines 128-1 or other engines, may be stored on the memory 120-1, for example, as the stored program data 136-1. The stored program data 136-1 may be organized as one or more databases. In certain embodiments, the program data 136-1 may be stored in a database system. The database system may reside within the memory 120-1. In other embodiments, the program data 136-1 may be remote, such as in a distributed computing and/or storage environment. For example, the program data 136-1 may be stored in a database system on a remote computing device.

The input/output interface 126-1 may facilitate interfacing with one or more input devices and/or one or more output devices. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The network interface 124-1 may facilitate communication with other computing devices and/or networks and/or other computing and/or communications networks. The network interface 124-1 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the network interface 124-1 may be configured to support a variety of network protocols, such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 121-1 may facilitate communication and/or interaction between the other components of the device 100-1, including the one or more processors 122-1, the memory 120-1, the input/output interface 126-1, and the network interface 124-1.

As noted, the device 100-1 also includes the various program engines 128-1 (or modules, elements, or components) to implement functionalities of the device 100-1, including a segment engine 130, a sales engine 131, an audience factor engine 132, an augmented consumer profiles engine 133, and/or a feedback engine 134. These elements may be embodied, for example, at least partially in the program engines 128-1. In other embodiments, these elements may be embodied or otherwise implemented in hardware of the device 100-1. The device 100-1 also includes web analytics data 138, audience segments data 139, vehicle sales data 140, sales goals data 141, and audience weights data 142 that may be stored in the program data 136-1 that may be generated, accessed, and/or manipulated by the program engines 128-1.

The segment engine 130 is configured to create a plurality of audience segments, from consumer data, corresponding to vehicle models. The plurality of audience segments can be stored as the audience segments data 139.

The sales engine 131 is configured to generate sales goal achievability data, which can also be described as a plurality of sales target ratios, corresponding to vehicle models, a plurality of sales forecasts corresponding to vehicle models, and/or a plurality of audience sales rates corresponding to vehicle models. The sales goal achievability data can be generated from the sales goals data 141 and/or the vehicle sales data 140. The plurality of sales forecasts can be generated from the sales goals data 141, the vehicle sales data 140, and/or the audience segments data 139. The plurality of audience sales rates can be generated from the vehicle sales data 140 and/or the audience segments data 139.

The audience factor engine 132 is configured to generate a plurality of audience weights data 142 from the sales goals data 141, the vehicle sales data 140, and/or the audience segments data 139. The augmented consumer profiles engine 133 is configured to augment a consumer profile using the audience weights data 142. The feedback engine 134 is configured to generate content for a consumer utilizing the audience weights data 142 and/or the augmented consumer profiles engine 133. The program engines 128-1 can utilize the web analytics data 138, the audience segments data 139, the vehicle sales data 140, the sales goals data 141, and the audience weights data 142.

FIG. 1B is a block diagram of a device 100-2 according to one embodiment. The device 100-2 includes a memory 120-2, one or more processors 122-2, a network interface 124-2, an input/output interface 126-2, and a system bus 121-2. The memory 120-2 is analogous to the memory 120-1. The one or more processors 122-2, the network interface 124-2, the input/output interface 126-2, and the system bus 121-2 are analogous to the one or more processors 122-1, the network interface 124-1, the input/output interface 126-1, and the system bus 121-1, respectively. The memory 120-2 may include a plurality of program engines 128-2 and program data 136-2. The memory 120-2 may be local to the device 100-2, as shown, or may be distributed and/or remote relative to the device 100-2.

The device 100-2 can implement an audience factor engine 132. The plurality of program engines 128-2 includes at least an audience goals engine 143, an audience size forecasts engine 144, an audience size gap engine 145, and an audience weights engine 146. The program data 136-2 includes audience goals data 149, audience size forecasts data 150, audience size gap data 151, and audience weights data 152.

The audience goals engine 143 generates the audience goals data 149 from the sales goal achievability data, the sales forecasts data, and/or the audience sales rates data generated by the sales engine 131 in FIG. 1A. The audience size forecasts engine 144 generates the audience size forecasts data 150 from the sales goal achievability data, the sales forecasts data, and/or the audience sales rates data generated by the sales engine 131. The audience size gap engine 145 generates the audience size gap data 151 by comparing the audience goals data 149 to the audience size forecasts data 150. The audience weights engine 146 can generate the audience weights data 142 from the audience segments data 139, the vehicle sales data 140, and the sales goals data 141.

In some examples, the devices 100-1 and/or 100-2 and/or the plurality of program engines 128-1 and 128-2 (e.g., the engines 130, 131, 132, 133, 134, 143, 144, 145, and/or 146) of FIGS. 1A and 1B can be implemented in a single computing device and/or a plurality of computing devices coupled via a computing network. The devices 100-1 and/or 100-2 and/or the plurality of program engines 128-1 and 128-2 can also be implemented in a cloud environment.

For example, each of the engines 130, 131, 132, 133, 134, 143, 144, 145, and/or 146 can be stored and/or generated in one or more computing devices. Each of the engines 130, 131, 132, 133, 134, 143, 144, 145, and/or 146 can store data, share the program data 136-1 and 136-2, and/or provide notifications with each other using one or more networks. The one or more networks can be any combination of private networks or public networks.

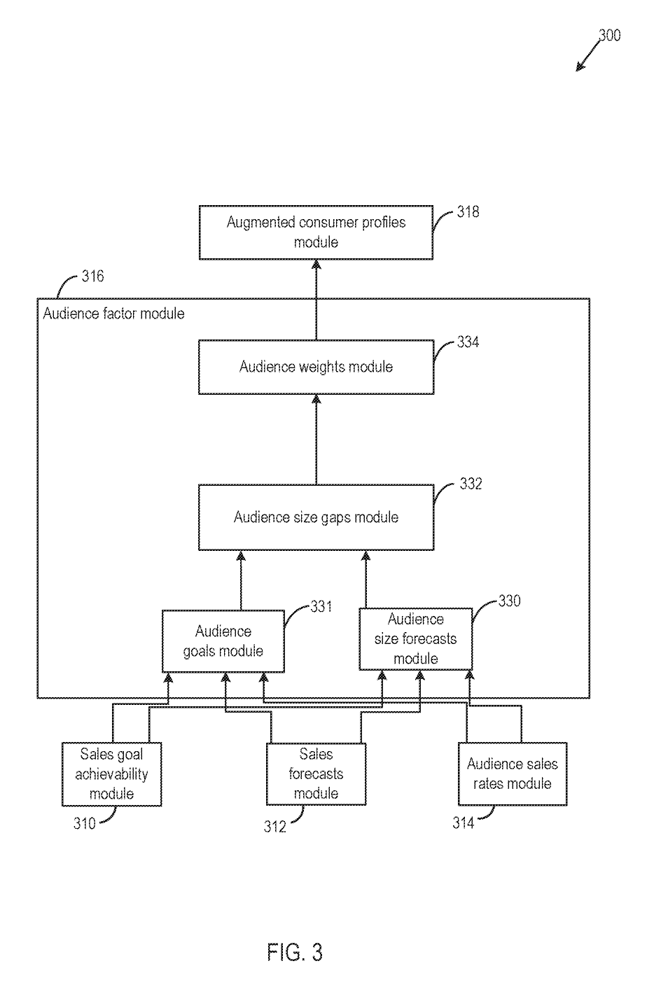

FIG. 2 is a block diagram of a system 200 for experience optimization according to one embodiment. The system 200 can utilize and/or generate web analytics data 202, audience segments data 204, vehicle sales data 206, and sales goals data 208. The system 200 can include a sales goal achievability module 210, a sales forecasts module 212, an audience sales rates module 214, an audience factor module 216, an augmented consumer profiles module 218, and a media module 220. The modules shown in FIGS. 2 and 3 can be software implementations of the engines 130, 131, 132, 133, 134, 143, 144, 145, and/or 146 of FIGS. 1A and 1B. As such, the modules can be implemented in the devices 100-1 and/or 100-2.

The web analytics data 202 can comprise consumer behavior data that can be gathered in real time and/or in batches. The system 200 can process the web analytics data 202 to generate the audience segments data 204.

The audience segments data 204 divide users visiting a website into subgroups based upon the users' use of the website. For example, users can be divided into subgroups based on a webpage visited by the users. The users can be divided into subgroups based on the interaction of the users with the website and/or webpage. In some examples, the subgroups can include vehicle models, vehicle types, and/or vehicle makers. For examples, a first audience segment can be a first quantity of users grouped into a first subgroup based on the first quantity of users' interest in a first vehicle model. A second audience segment can be a second quantity of users grouped into a second subgroup based on the second quantity of users' interest in a second vehicle model. In some examples, the audience segments data 204 can include audience segments that are exclusive or inclusive. That is, users can belong to a single audience segment and/or to multiple audience segments.

The audience segments data 204 can be composed from consumer profiles. A consumer profile can include a plurality of preferences of a consumer. The plurality of preferences of the consumer can be associated with vehicle models. For example, each of the plurality of preferences can correspond to a different vehicle model and a corresponding audience segment.

The plurality of preferences can be represented using numerical values. For example, a consumer profile can comprise a first user with a 0.5 preference in a first vehicle model, a 0.3 preference in a second vehicle model, and a 0.2 preference in a third vehicle model. The preferences can be used to customize content presented to corresponding users. For example, content presented to the first user can target the first vehicle model. Subsequent content presented to a user can target the second vehicle model. The implementations of a customer profile can be different than those shown herein. The customizing of content to a customer based on the customer profile can also be different than shown herein. The examples provided are illustrative and should not be interpreted as limiting.

The vehicle sales data 206 can include data describing vehicle sales for a plurality of vehicle models. The vehicle sales data 206 can describe actual vehicle sales in a time duration. A time duration can also be referred to as a duration of time. As used herein, a time duration can include a duration of time between a start time and an end time. A time duration can be a minute, an hour, a day, or a week, among other examples of a time duration. In some examples, the vehicle sales data 206 can describe a present quantity of vehicle sales at a time that is after the start time of the time duration but before the end time of the time duration. That is, the vehicle sales data 206 can describe ongoing vehicle sales.

The vehicle sales data 206 can be generated offline. That is, in some examples vehicle sales used to generate, by a computing device, the vehicle sales data 206 do not occur on a website but can occur offline. The vehicle sales can also occur online or in a combination of online and offline. As used herein, online refers to the real time availability of data. Offline refers to the availability of data not in real time but in batches. For example, the offline generation of vehicle sales data 206 describes that the vehicle sales data 206 is not available to the system 200 in real time but rather is made available to the system 200 in batches at diverse time intervals. Data can be available in a combination of online and offline if portions of the data are available in real time while other portions of the data are not available in real time.

The vehicle sales data 206 can be stored in hardware using software and made available to the system 200. For example, if the vehicle sales data 206 are stored offline, then the vehicle sales data 206 can be stored in one or more databases that are stored in one or more servers and/or on a cloud system. The vehicle sales data 206 can be provided to the system 200 via a private network and/or a public network.

The vehicle sales data 206 can be used to determine an inventory of vehicles of a plurality of vehicle models at a dealership. For example, given an inventory of a dealership at a beginning of a time period, the vehicle sales data 206 can be subtracted from the inventory to determine an inventory of the dealership at a point in time. The inventory can define the availability of particular vehicles of a vehicle mode, a plurality of vehicles of a vehicle type, and/or a plurality of vehicles of a vehicle maker.

A dealership can comprise a plurality of vehicles at a location and/or at a plurality of locations. A dealership can be owned by a single entity and/or a plurality of entities. A dealership can comprise an Internet presence and/or a brick-and-mortar presence.

The system 200 can also comprise the sales goals data 208. The sales goals data 208 can describe a sales goal for each of a plurality of vehicle models. For example, the sales goals data 208 can comprise a first sales goal for a first vehicle model and a second sales goal for a second vehicle model. The sales goals data 208 can also be defined by the time duration. The time duration associated with the sales goals data 208 can be a same time duration as, and/or a different time duration from, the time duration associated with the vehicle sales data 206. For example, a time duration of a month can be associated with the sales goals data 208 and the vehicle sales data 206. The sales goals data 208 can be defined by a dealership and/or a plurality of dealerships.

In some examples, an inventory of a dealership can be used to generate the sales goals data 208. The inventory can also affect the vehicle sales data 206 and/or the audience segments data 204.

The sales goal achievability module 210 can generate sales goal achievability data based on the sales goals data 208, the vehicle sales data 206, and/or the vehicle sales data 204 via one or more computing device. For example, the sales goal achievability module 210 can compare the sales goals data 208 and the vehicle sales data 206 to generate the sales goal achievability data. The computing devices can include hardware and software. For example, the computing device can comprise memory and one or more processing devices. The computing device can comprise software in the form of computer readable instructions to store and process data.

The computing device can be local to the system 200 and/or external to the system 200. For example, the computing device that generates the sales goal achievability module 210 can be housed in a cloud system that is external to the system 200.

The sales goal achievability module 210 can generate sales goal achievability data for each vehicle model. The sales goal achievability data can include sales forecasts utilizing model audience data and vehicle model sales relative to the model sales goal. The sales forecasts module 212 can generate sales forecasts data from the sales goals data 208, the vehicle sales data 206, and/or the audience segments data 204. The sales forecasts data can describe an expected quantity of sales for each of a plurality of vehicle models. For example, the expected quantity of sales can define a quantity of sales that are expected at an end time associated with a time duration. Each sales forecast from the sales forecasts data can be associated with a different one of the vehicle models offered by a dealership.

The sales forecasts data can be used by the system 200 to determine audience size forecasts data via audience size forecasts module 330 in FIG. 3. The audience size forecasts data can define the audience size needed to achieve the sales forecast associated with the sales forecast data. That is, the audience size forecasts can be a desired quantity of customers that are targeted to visit a dealership and/or a website associated with the dealership to achieve the sales forecast. The audience size forecasts can be generated, via a computing device, from the sales forecast data, the audience sales rates data, and/or the sales goal achievability data.

The audience sales rates module 214 can generate the audience sales rates based on the vehicle sales data 206 and the audience segments data 204. The audience sales rates can define a ratio of an audience size to a sale. That is, the audience sales rates can define a sales rate for a specific audience. For example, the audience sales rates module 214 can define that 200 shoppers of a vehicle model are expected to visit a dealership before a sale of the vehicle model is made.

The audience factor module 216 can generate a plurality of audience weights based on the sales goals data 208, the vehicle sales data 206, and/or the audience segments data 204. The audience factor module 216 receives the sales goal achievability data, the sales forecasts, and/or the audience sales rates to generate a plurality of audience weights, as described in FIG. 3. The audience weights can be used to augment a consumer profile.

Each of the plurality of audience weights can correspond to a different audience segment and/or vehicle model. The plurality of audience weights can describe a dealership's needs (e.g., dealership business needs).

The augmented consumer profiles module 218 can combine the audience weights with consumer profiles retrieved from the audience segments data 204 to generate the augmented consumer profiles. The augmented consumer profiles can merge the dealership needs with customer interests by applying the audience weights to the consumer profiles.

In some examples, the audience weights can be applied to a consumer profile that represents a particular consumer and/or a plurality of consumers. For example, if the consumer profile represents a consumer, then content provided to the consumer can be selected based on the augmented consumer profiles created by merging the audience weights and the consumer profile. If the consumer profile represents a plurality of consumers, then the content provided to the plurality of consumers can be selected based on the augmented consumer profiles created by merging the audience weights with a merged consumer profile. The merged consumer profile can be created by merging the plurality of consumer profiles into a single profile. Merging can include averaging and/or summing, among other operations that can be used to merge profiles.

The augmented consumer profiles can be provided to the media module 220. The media module 220 can select a form of media based on the augmented consumer profiles. The augmented consumer media can include emails, websites, social media, and/or advertising.

The media module 220 can provide feedback in the form of the web analytics data 202 through the actions that the consumers take as a result of providing targeted content to consumers. The feedback can be provided continuously and/or in batches over a duration of time.

In some examples, the system 200 can be implemented in a single computing device and/or a plurality of computing devices coupled via a computing network. The system 200 can also be implemented in a cloud environment.

For example, each of the web analytics data 202, the audience segments data 204, the vehicle sales data 206, the sales goals data 208, the sales goal achievability module 210, the sales forecasts module 212, the audience sales rates module 214, the audience factor module 216, the augmented consumer profiles module 218, and/or the media module 220 can be stored, generated, and/or executed in one or more computing devices. Each of the links connecting the web analytics data 202, the audience segments data 204, the vehicle sales data 206, the sales goals data 208, the sales goal achievability module 210, the sales forecasts module 212, the audience sales rates module 214, the audience factor module 216, the augmented consumer profiles module 218, and/or the media module 220 can represent one or more networks. The one or more networks can be any combination of private networks or public networks.

FIG. 3 is a block diagram for an audience factor module 316 according to one embodiment. The audience factor module 316 is analogous to the audience factor module 216 in FIG. 2. An audience sales rates module 314, a sales forecasts module 312, and a sales goal achievability module 310 are analogous to the audience sales rates module 214, the sales forecasts module 212, and the sales goal achievability module 210 in FIG. 2, respectively. An augmented consumer profiles module 318 is also analogous to the augmented consumer profiles module 218 in FIG. 2.

The audience factor module 316 can receive the sales target rations from the sales goal achievability module 310, the sales forecasts from the sales forecasts module 312, and the audience sales rates from the audience sales rates module 314. An audience size forecasts module 330 can generate audience size forecasts (e.g., audience size forecasts data) for each vehicle model from the sales goal achievability data, the sales forecasts data, and/or the audience sales rates data. The audience size forecasts data can describe the expected model audience and/or the visitor volume based on the data to date in the forecast period assuming the current system state is maintained. An audience goals module 331 can generate audience goals data for each vehicle model using the sales goal achievability data, the sales forecasts data, and/or the audience sales rates data. The audience goals data can describe the needed model audience and/or the visitor volume based on the desired model sales. The audience goals data can describe an audience size needed to meet the sales goals data associated with the sales goal achievability module 310.

An audience size gaps module 332 can compare the audience goals data to the audience size forecasts data to generate audience size gaps data. The audience size gaps data can comprise a plurality of audience size gaps. The audience size gaps can be the difference between the audience goals and the audience size forecasts. For example, if the audience goal needed to meet the sales target ratio data is X and the audience size forecast needed to meet the sales forecasts data is Y, then the audience size gap can be expressed as X-Y.

An audience weights module 334 can generate a plurality of audience weights from the audience size gap data. The audience size gap data for each vehicle model can be converted to the audience weights using a plurality of policies. An example policy can define that as a audience size gap increases, the associated audience weights increase. For example, if the audience size gap data for a first vehicle is 2015 and the audience size gap data for a second vehicle is 574, then the audience weights associated with the first vehicle can be greater than the audience weights associated with the second vehicle.

By analyzing audience segments for models, the sales forecasts data for a model, the sales goal achievability data for a model, the audience sales rate data for models, inventory available for a model, and/or the sales goals for a model, the system (e.g., the device 100-1 and device 100-2 in FIG. 1) via the audience size forecasts module 330 can create the forecast of audience volume needed to achieve the sales goal for a model. The augmented consumer profiles module 318 can also utilize a set of weighting coefficients (e.g., the audience weights) to generate the augmented consumer profiles. The augmented consumer profiles can be utilized to encourage audience growth into segments based on the relative distance between the forecast and goals.

For example: If a consumer has expressed interest in an F-150, the consumer might initially be placed in “F-150” and “Truck” segments in a data management platform (DMP). When that consumer visits a Chevrolet and/or a GMC dealer the system can associate that consumer with Sierra 1500 and Silverado 1500 audience segments, via cross-selling. The system can have a choice on what content to show the consumer, either Sierra or Silverado. Based on the relationships between audience size, the audience sales rates, and the current audience size forecasts (e.g., generated by the audience size forecasts module 330), and the desired business goals (e.g., the sales goal achievability), the system can select whether to show the consumer Sierra 1500 or Silverado 1500 content. The feedback loop ensures an optimal association between the consumer's interests and the dealer's business goals with respect to the digital experiences provided to the consumer.

The media module can utilize the augmented consumer profiles to personalize consumer content. The consumer content can be personalized if, for example, the consumer interest is unknown. That is, the consumer content can be personalized if the consumer profile is not included in the consumer profiles stored in the DMP associated with the audience segments. The augmented consumer profiles can be used to personalize the consumer content where the consumer has expressed interest in multiple audience segments. That is, the augmented consumer profiles can be used as a tiebreaker between multiple audience segments. The augmented consumer profiles can be used to personalize the consumer content where an expressed consumer intent is mapped to multiple possible adjacent audience segments. That is, the augmented consumer profiles can be used to cross-sell a vehicle model based on the consumer showing interest in an associated vehicle model.

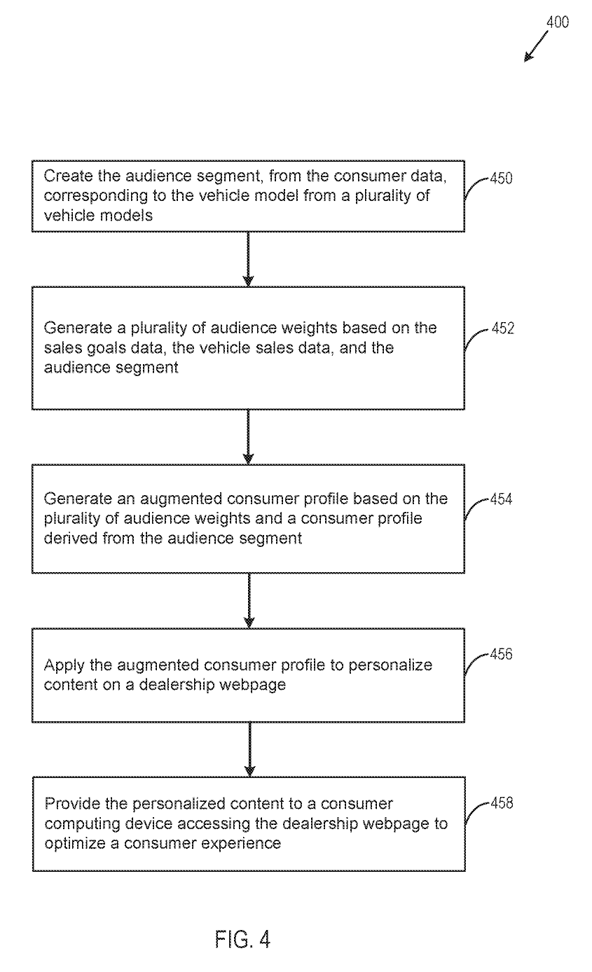

FIG. 4 is a flowchart of a method 400 for experience optimization according to one embodiment. The method 400 can include creating 450 the audience segment, from the consumer data, corresponding to the vehicle model from a plurality of vehicle models; generating 452 a plurality of audience weights based on the sales goals data, the vehicle sales data, and the audience segment; generating 454 an augmented consumer profile based on the plurality of audience weights and a consumer profile derived from the audience segment; applying 456 the augmented consumer profile to personalize content on a dealership webpage; and providing 458 the personalized content to a consumer computing device accessing the dealership webpage to optimize a consumer experience.

The consumer data can comprise web analytics data. The sales goals data can describe a desired quantity of sales of the vehicle model. The vehicle sales data can describe an actual quantity of sales of the vehicle model.

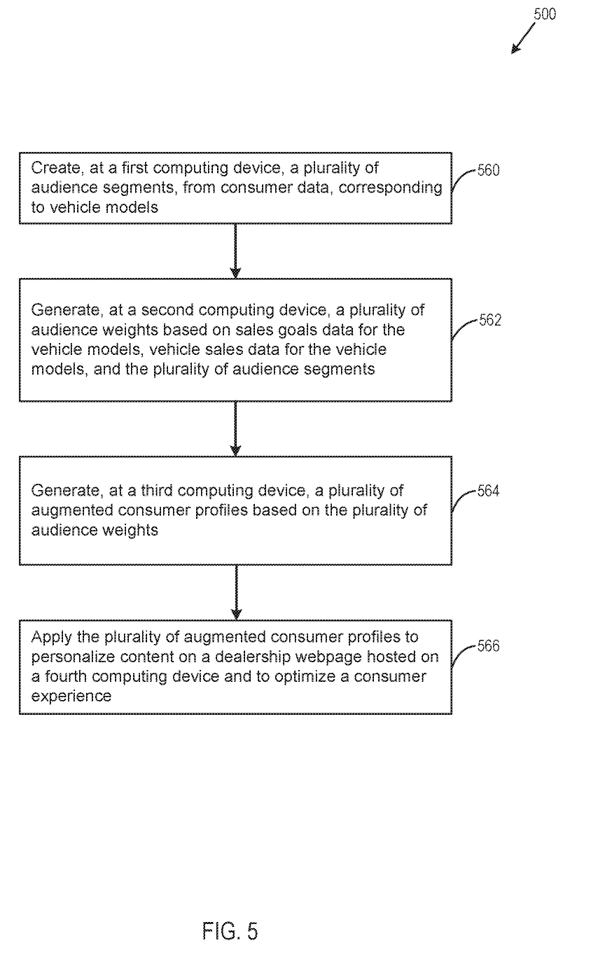

FIG. 5 is a flowchart of a method 500 for experience optimization according to one embodiment. The method 500 can include creating 560, at a first computing device, a plurality of audience segments, from consumer data, corresponding to vehicle models; generating 562, at a second computing device, a plurality of audience weights based on sales goals data for the vehicle models, vehicle sales data for the vehicle models, and the plurality of audience segments; generating 564, at a third computing device, a plurality of augmented consumer profiles based on the plurality of audience weights; and applying 566 the plurality of augmented consumer profiles to personalize content on a dealership webpage hosted on a fourth computing device and to optimize a consumer experience.

The method 500 further comprises generating default content for a consumer with a default profile based on the plurality of augmented consumer profiles. The method 500 further comprises generating content associated with an interest for a consumer with a profile comprising the interest based on the plurality of augmented consumer profiles. The method 500 further comprises generating content associated with a vehicle model for a consumer with a profile comprising the vehicle model based on the plurality of augmented consumer profiles.

The method 500 further comprises generating a sales target ratio by comparing the sales goals data to the vehicle sales data. The method 500 also comprises joining the plurality of audience segments, the sales goals data, and the vehicle sales data to generate a sales forecast. The method 500 also comprises comparing the plurality of audience segments to the vehicle sales data to generate an audience sales rate. Generating the plurality of audience weights further comprises generating the plurality of audience weights based on the sales target ratio, the sales forecast, and the audience sales rate. The method 500 can further comprise generating a forecast for a target audience size goal for each of the plurality of vehicle models from the sales target ratio, the sales forecast, and the audience sales rate.

The method 500 can also comprise generating an audience size gap for each model from the forecast for the target audience size goal and the sales target ratio. The audience size gap can comprise a gap between the target audience size goal needed to meet the sales target ratio and an audience size forecast needed to meet the sales forecast. The audience size goal can be generated from the sales target ratio and the audience sales rate. The audience size forecast can be generated from the sales forecast and the audience sales rate.

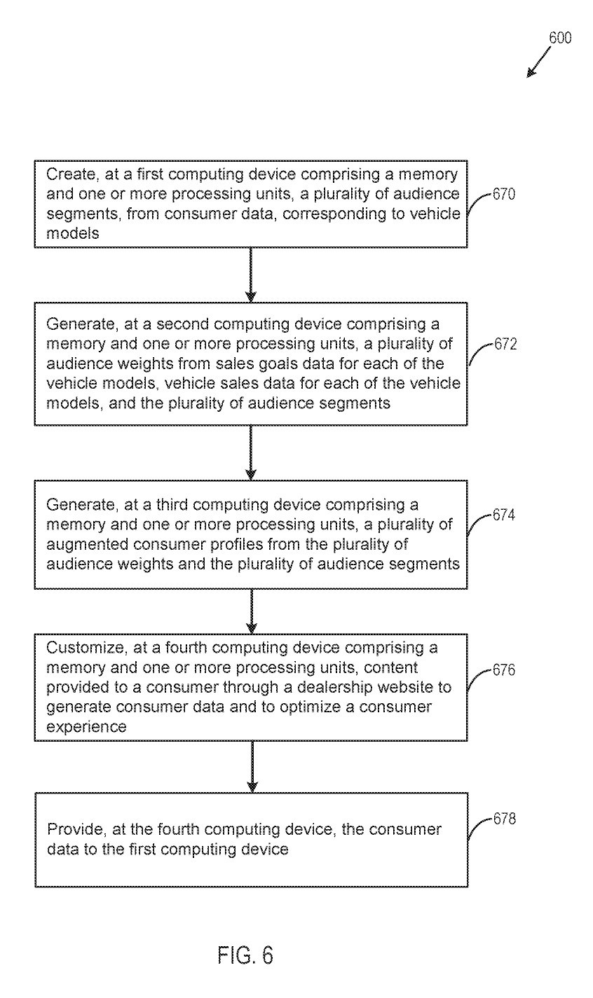

FIG. 6 is a flowchart of a method 600 for experience optimization according to one embodiment. The method 600 can include creating 670, at a first computing device comprising a memory and one or more processing units, a plurality of audience segments, from consumer data, corresponding to vehicle models; generating 672, at a second computing device comprising a memory and one or more processing units, a plurality of audience weights from sales goals data for each of the vehicle models, vehicle sales data for each of the vehicle models, and the plurality of audience segments; generating 674, at a third computing device comprising a memory and one or more processing units, a plurality of augmented consumer profiles from the plurality of audience weights and the plurality of audience segments; customizing 676, at a fourth computing device comprising a memory and one or more processing units, content provided to a consumer through a dealership website to generate consumer data and to optimize a consumer experience; and providing 678, at the fourth computing device, the consumer data to the first computing device.

The method can also include providing feedback to the first computing device every predetermined time interval. Providing the consumer data to the first computing device can further comprise providing the consumer data to the first computing device in real time. The method 500 can also include generating web analytics data, at the first computing device, from the consumer data. Creating the plurality of audience segments from the consumer data can further comprise creating the plurality of audience segments from the web analytics data.

Furthermore, the described features, operations, or characteristics may be arranged and designed in a wide variety of different configurations and/or combined in any suitable manner in one or more embodiments. Thus, the detailed description of the embodiments of the systems and methods is not intended to limit the scope of the disclosure, as claimed, but is merely representative of possible embodiments of the disclosure. In addition, it will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable storage medium having stored instructions thereon that may be used to program a computer (or other electronic device) to perform processes described herein. The computer-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions.

As used herein, a software module or component may include any type of computer instruction or computer-executable code located within a memory device and/or computer-readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be obvious to those having skill in the art that many changes may be made to the details of the above-described embodiments without departing from the underlying principles of the invention. The scope of the present invention should, therefore, be determined only by the following claims.

What is claimed is:

1. A device for experience optimization for a website using audience segmentation data, comprising:
an electronic memory to store consumer data corresponding to a vehicle model, sales goals data for the vehicle model, vehicle sales data for the vehicle model, and an audience segment; and
one or more processing units configured to:
create the audience segment, from the consumer data, corresponding to the vehicle model from a plurality of vehicle models;
generate a plurality of audience weights based on the sales goals data, the vehicle sales data, and the audience segment;
generate an augmented consumer profile based on the plurality of audience weights and a consumer profile derived from the audience segment;
apply the augmented consumer profile to personalize content on a dealership webpage; and
provide the personalized content to a consumer computing device accessing the dealership webpage to optimize a consumer experience.

2. The device of claim 1, wherein the consumer data comprise web analytics data.

3. The device of claim 1, wherein the sales goals data describe a desired quantity of sales of the vehicle model.

4. The device of claim 1, wherein the vehicle sales data describe an actual quantity of sales of the vehicle model.

5. A computer-readable storage medium having stored thereon instructions that, when implemented by a computing device, cause the computing device to:
create, at a first computing device, a plurality of audience segments, from consumer data, corresponding to vehicle models;
generate, at a second computing device, a plurality of audience weights based on sales goals data for the vehicle models, vehicle sales data for the vehicle models, and the plurality of audience segments;
generate, at a third computing device, a plurality of augmented consumer profiles based on the plurality of audience weights; and
apply the plurality of augmented consumer profiles to personalize content on a dealership webpage hosted on a fourth computing device and to optimize a consumer experience.

6. The computer-readable storage medium of claim 5, further comprising instructions to generate default content for a consumer with a default profile based on the plurality of augmented consumer profiles.

7. The computer-readable storage medium of claim 5, further comprising instructions to generate content associated with an interest for a consumer with a profile comprising the interest based on the plurality of augmented consumer profiles.

8. The computer-readable storage medium of claim 5, further comprising instructions to generate content associated with a vehicle model for a consumer with a profile comprising the vehicle model based on the plurality of augmented consumer profiles.

9. The computer-readable storage medium of claim 5, further comprising instructions to generate a sales target ratio by comparing the sales goals data to the vehicle sales data.

10. The computer-readable storage medium of claim 9, further comprising instructions to join the plurality of audience segments, the sales goals data, and the vehicle sales data to generate a sales forecast.

11. The computer-readable storage medium of claim 10, further comprising instructions to compare the plurality of audience segments to the vehicle sales data to generate an audience sales rate.

12. The computer-readable storage medium of claim 11, wherein the instructions to generate the plurality of audience weights comprise instructions to generate the plurality of audience weights based on the sales target ratio, the sales forecast, and the audience sales rate.

13. The computer-readable storage medium of claim 11, further comprising instructions to generate a forecast for a target audience size goal for each of the plurality of vehicle models from the sales target ratio, the sales forecast, and the audience sales rate.

14. The computer-readable storage medium of claim 13, further comprising instructions to generate an audience size gap for each model from the forecast for the target audience size goal and the sales target ratio.

15. The computer-readable storage medium of claim 14, wherein the audience size gap comprises a gap between the target audience size goal needed to meet the sales target ratio and an audience size forecast needed to meet the sales forecast.

16. The computer-readable storage medium of claim 15, wherein the audience size goal is generated from the sales target ratio and the audience sales rate.

17. The computer-readable storage medium of claim 15, wherein the audience size forecast is generated from the sales forecast and the audience sales rate.

18. A method for experience optimization for a website using audience segmentation data, comprising:
creating, at a first computing device comprising a memory and one or more processing units, a plurality of audience segments, from consumer data, corresponding to vehicle models;
generating, at a second computing device comprising a memory and one or more processing units, a plurality of audience weights from sales goals data for each of the vehicle models, vehicle sales data for each of the vehicle models, and the plurality of audience segments;
generating, at a third computing device comprising a memory and one or more processing units, a plurality of augmented consumer profiles from the plurality of audience weights and the plurality of audience segments;
customizing, at a fourth computing device comprising a memory and one or more processing units, content provided to a consumer through a dealership website to generate consumer data and to optimize a consumer experience; and
providing, at the fourth computing device, the consumer data to the first computing device.

19. The method of claim 18, further comprising providing feedback to the first computing device every predetermined time interval.

20. The method of claim 18, wherein providing the consumer data to the first computing device further comprises providing the consumer data to the first computing device in real time.

21. The method of claim 18, further comprising generating web analytics data, at the first computing device, from the consumer data.

22. The method of claim 21, wherein creating the plurality of audience segments from the consumer data further comprises creating the plurality of audience segments from the web analytics data.
